(19) United States
(12) Patent Application Publication
(10) Pub. No.: US 2004/0141732 A1
(43) Pub. Date: Jul. 22, 2004

(54) Moving-picture code amount control method, moving-picture recording method, moving-picture code amount control apparatus and moving-picture recording apparatus

(76) Inventor: Kenji Sugiyama, Yokosuka-Shi (JP)

Correspondence Address: JACOBSON HOLMAN, PROFESSIONAL LIMITED LIABILITY COMPANY,, 400 Seventh Street, N.W., Washington, DC, 20004, US

(21) Appl. No.: 10/734,163

(22) Filed: Dec. 15, 2003

(30) Foreign Application Priority Data
Jan. 22, 2003 (JP) 2003-13446

(51) Int. Cl. H04N 7/26

(52) U.S. Cl. 386/111; 386/112

(57) ABSTRACT

The amount of codes is controlled, which are generated during re-coding in conversion of a first bitstream obtained by efficient coding of a moving-picture video signal to a second bitstream. Extracted, from the first bitstream, is at least either information on code amount or information on quantization, as a parameter indicating moving-picture coding difficulty. Otained, from the parameter per given period, is an amount of quasi-generated codes which is estimated to be required for achieving a given picture quality. The amount of quasi-generated codes is adjusted for each of the given period to obtain a target code amount. The target code amount is assigned to a given portion of the moving-picture video signal so that a total code amount of the given portion of the moving-picture video signal matches a recordable total code amount for a storage medium for storing the given portion of the moving-picture video signal. The first bitstream is re-coded while code amount control is performed in accordance with the target code amount, thus the first bitstream being converting into the second bitstream to be recorded in the storage medium.

### BACKGROUND OF THE INVENTION

The present invention relates to a moving-picture code amount control method, a moving-picture recording method, a moving-picture code amount control apparatus and a moving-picture recording apparatus. Particularly, this invention relates to such methods and apparatuses for recording moving-picture bitstreams in a storage medium recordable at variable bit rate with no vacant regions in highly efficient coding of moving-picture video signals into digital signals at fewer code amounts for data transfer, storage and display.

In inter-picture predictive coding, for example, according to the MPEG (Moving Picture Experts Groups) standards, moving-picture coding difficulty (the code amount required for achieving a given picture quality) varies according to the transition (time) of moving-picture video signals.

Moving-picture bitstreams are thus required to be coded at a variable bit rate and a constant picture quality when recorded on a storage medium recordable at variable bit rate, such as, an HDD (Hard Disc drive) and a DVD (digital Versatile Disc).

Such coding technique requires precise code amount control for recording moving pictures (such as a TV program) in a storage medium having finite storage capacity.

The inventor of the present invention has already proposed a moving-picture code amount control and moving-picture recording apparatus such as shown in FIG. 1, in Japanese Patent No. 2950065, for recording moving-picture video signals at a constant quality with no excess or deficiency of code amounts.

In detail, moving-picture video signals to be recorded are subjected two-step coding: tentative coding with quantization at a fixed step width to give distribution of generated code amounts for target code amount settings according to the transition (time) of the moving-picture signals; and actual coding based on target code amounts.

A moving-picture code amount control and moving-picture recording apparatus shown in FIG. 1 performs two-step coding, tentative coding at an encoder 2 and actual coding at an encoder 4.

An uncompressed digital moving-picture video signal is supplied to the encoder 2 and also a first-stage storage medium 3 for storing all target moving pictures, via a video input terminal 1.

In tentative coding, the encoder 2 encodes the uncompressed digital moving-picture video signal in order to achieve a constant picture quality in reproduction, but under no control based on generated code amounts.

The generated code amounts are supplied to a code amount monitor 9 for monitoring the amounts per GOP (Group of Pictures), frame or slice (16 lines), etc. The monitored data are stored in the code amount monitor 9 for the entire period of the moving-picture video signal and then supplied to a target rate setter 10.

On completion of tentative coding at the encoder 2, the target rate setter 10 adjusts the generated code amounts so that the amounts match the capacity of a second-stage storage medium 5, to set a target code amount and store this target code amount for the entire period of the moving-picture video signal.

In actual coding, the moving-picture video signal is supplied from the first-stage storage medium 3 to the encoder 4 and coded under code amount control in accordance with the target code amount supplied from the target rate setter 10.

An actual code amount has an error for each data unit, such as GOP, against the target code amount. The error is, however, absorbed in control of the succeeding GOP. The total error for the generated code amounts at the end of the moving-picture video signal is thus a fraction of the code amount of one GOP. Therefore, the target code amount can be set at a relatively small amount against this small total error, thus the total code amount becomes within the capacity of the second-stage storage medium 5.

The input uncompressed digital moving-picture video signal is recorded in the first-stage storage medium 3. Thus, this storage medium 3 may be a VTR (Video Tape Recorder) that can supply moving-picture signals to the moving-picture code amount control and moving-picture recording apparatus shown in FIG. 1. In use of such a VTR, the signals to be supplied to the encoder 4 for actual coding are only those from the encoder 2 for tentative coding via the code amount monitor 9 and the target rate setter 10.

Bitstreams of the moving-picture video signal coded as described above are then supplied from the encoder 4 to the second-stage storage medium 5 and recorded therein.

The second-stage storage medium 5 is, for example, a DVD which is used in reproduction, not the first-stage storage medium 3. Bitstreams read from the second-stage storage medium 5 are decoded by a decoder 7 for reproducing moving pictures. The moving pictures are output via a video output terminal 8.

In addition to the above moving-picture code amount control and moving-picture recording apparatus shown in FIG. 1, there is a moving-picture recording apparatus capable of recording and reproduction to and from different types of storage media, such as, an HDD and a DVD. Coding and code amount control techniques in recording are the same for the different types of storage media.

In the moving-picture code amount control and moving-picture recording apparatus shown in FIG. 1, tentative coding is performed with quantization at a fixed step width to give distribution of generated code amounts for target code amount settings.

In other words, tentative coding is performed separately from actual coding. Bitstreams produced in tentative coding are used only for code amount monitoring, not for actual coding.

The tentative coding causes 2 times or more of processing time compared to actual coding only.

In the known moving-picture recording apparatus capable of recording and reproduction to and from different types of storage media, bitstreams coded under the same code amount control technique are recorded in different types of storage media. Accuracy of the code amount control technique thus depends the types of storage media.

### SUMMARY OF THE INVENTION

A purpose of the present invention is to provide a moving-picture code amount control method, a moving-picture recording method, a moving-picture code amount control apparatus and a moving-picture recording apparatus, capable of recoding bitsteams once recorded in a first-stage storage medium in a second-stage storage medium at an optimum variable transfer rate with no tentative coding.

The present invention provides a method of controlling the amount of codes generated during re-coding in conversion of a first bitstream obtained by efficient coding of a moving-picture video signal to a second bitstream, the method comprising the steps of: extracting, from the first bitstream, at least either information on code amount or information on quantization, as a parameter indicating moving-picture coding difficulty; obtaining, from the parameter per given period, an amount of quasi-generated codes which is estimated to be required for achieving a given picture quality; adjusting the amount of quasi-generated codes for each of the given period to obtain a target code amount; assigning the target code amount to a given portion of the moving-picture video signal so that a total code amount of the given portion of the moving-picture video signal matches a recordable total code amount for a storage medium for storing the given portion of the moving-picture video signal; and re-coding the first bitstream while performing code amount control in accordance with the target code amount, thus converting the first bitstream into the second bitstream to be recorded in the storage medium.

Moreover, the present invention provides a moving-picture recording method comprising the steps of: recording a first bitstream obtained by efficient coding of a moving-picture video signal in a first storage medium, under code amount control for targeting a given fixed transfer bit rate; extracting, from the first bitstream, at least either information on code amount or information on quantization, as a parameter indicating moving-picture coding difficulty; obtaining, from the parameter per given period, an amount of quasi-generated codes which is estimated to be required for achieving a given picture quality; adjusting the amount of quasi-generated codes for each of the given period to obtain a target code amount; assigning the target code amount to a given portion of the moving-picture video signal so that a total code amount of the given portion of the moving-picture video signal matches a recordable total code amount for a second storage medium for storing the given portion of the moving-picture video signal; and re-coding the first bitstream to convert the first bitstream into a second bitstream having a variable bit rate while performing code amount control in accordance with the target code amount; and recording the second bitstream in the second storage medium at the variable bit rate.

Furthermore, the present invention provides a moving-picture code amount control apparatus comprising: an information extractor to extract at least either information on code amount or information on quantization, as a parameter indicating moving-picture coding difficulty, from a first bitstream obtained by efficient coding of a moving-picture video signal, and obtain, from the parameter per given period, an amount of quasi-generated codes which is estimated to be required for achieving a given picture quality; a target code amount setter to adjust an amount of quasi-generated codes for each of the given period to obtain a target code amount and assign the target code amount to a given portion of the moving-picture video signal so that a total code amount of the given portion of the moving-picture video signal matches a recordable total code amount for a storage medium for storing the given portion of the moving-picture video signal; and an encoder to re-code the first bitstream while performing code amount control in accordance with the target code amount, thus converting the first bitstream into a second bitstream to be recorded in the storage medium.

Still furthermore, the present invention provides a moving-picture recording apparatus comprising: a first recorder to record a first bitstream obtained by efficient coding of a moving-picture video signal in a first storage medium, under code amount control for targeting a given fixed transfer bit rate; an information extractor to extract, from the first bitstream, at least either information on code amount or information on quantization, as a parameter indicating moving-picture coding difficulty, and obtain, from the parameter per given period, an amount of quasi-generated codes which is estimated to be required for achieving a given picture quality; a target code amount setter to adjust an amount of quasi-generated codes for each of the given period to obtain a target code amount and assign the target code amount to a given portion of the moving-picture video signal so that a total code amount of the given portion of the moving-picture video signal matches a recordable total code amount for a second storage medium for storing the given portion of the moving-picture video signal; a bitstream convertor to re-code the first bitstream while performing code amount control in accordance with the target code amount, thus converting the first bitstream into a second bitstream having a variable transfer bit rate; and a recorder to recode the second bitstream in the second storage medium at the variable transfer bit rate.

### BRIEF DESCRIPTION OF DRAWINGS

FIG. 1 shows a block diagram of a known moving-picture code amount control and moving-picture recording apparatus;

FIG. 2 shows a block diagram of a first embodiment of a moving-picture recording system having a moving-picture code amount control apparatus and a moving-picture recording apparatus according to the present invention;

FIG. 3 illustrates target bit rates (depicted by dot lines) and actual bit rates (depicted by solid lines);

FIG. 4 shows a block diagram of a second embodiment of a moving-picture recording system having a moving-picture code amount control apparatus and a moving-picture recording apparatus according to the present invention; and

FIG. 5 shows a block diagram of a third embodiment of a moving-picture code amount control and moving-picture recording apparatus according to the present invention.

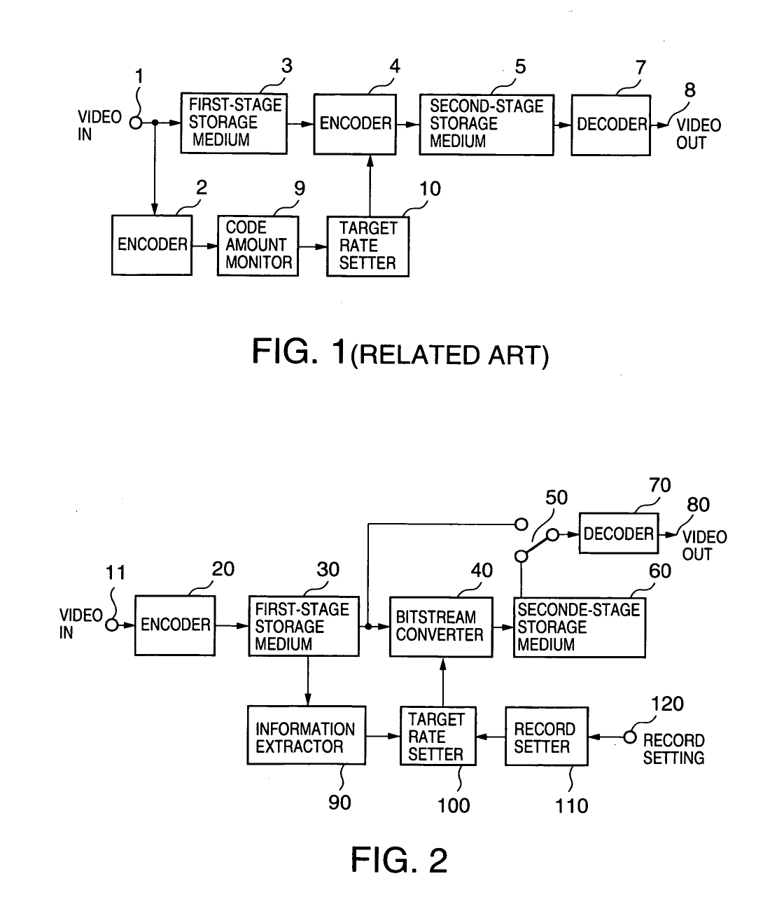

### DETAILED DESCRIPTION OF PREFERRED EMBODIMENTS

Several embodiments according to the present invention will be disclosed with reference to the attached drawings.

Shown in FIG. 2 is a first embodiment of a moving-picture recording system having a moving-picture code amount control apparatus and a moving-picture recording apparatus according to the present invention.

In FIG. 2, an analog moving-picture video signal or an uncompressed digital moving-picture video signal is supplied to an encoder 20 via a video input terminal 11. The moving-picture video signal is coded into a first bitstream while it is subjected to code amount control to have a given target transfer bit rate. The first bitstream is recorded in a first-stage storage medium 30.

The encoder 20 employs a coding technique according to, for example, the MPEG standards, and a code amount control technique that is feedback control based on sufficiency of a virtual buffer having a given capacity. The amount of codes generated by the encoder 20 largely varies when the virtual buffer capacity is bigger than an actual buffer capacity, thus a bitstream being generated at a variable transfer rate.

The first-stage storage medium 30, if capable of storing a bitstream generated at a variable transfer rate, can offer higher picture quality than when it stores a bitstream generated at a fixed transfer rate.

Nevertheless, the moving-picture video signal is coded into the first bitstream at a given target transfer bit rate, in this embodiment, like under known code amount control at a fixed transfer rate. The target bit rate is switched by a rate switch (not shown), but not within one moving picture.

The first-stage storage medium 30 is usually undetachable, such as, an HDD having capacity of about 100 GB (bytes), for long-hour recording at a high bit rate, for example, 38-hour recording at 6 Mbps.

The first bitstream recorded in the first-stage storage medium 30 is read by a reader (not shown) and supplied to a switch 50 and a bitstream converter 40.

In direct reproduction, the first bitstream is supplied to a decoder 70 via the switch 50. The first bitstream is decoded into moving pictures which are output via a video output terminal 80.

In re-recording, the first bitstream supplied to the bitstream converter 40 is re-encoded and converted into a different format of bitstream so that it can be recorded in a second-stage storage medium 60.

The second-stage storage medium 60 is a detachable storage medium, such as, a 4.7 GB-DVD-R (RAM or RW) or another disc-type storage medium having a large capacity of about 25 GB. The 4.7 GB-DVD-R (RAM or RW) requires a transfer rate of 3 Mbps (on average) for about 3-hour recording.

The second-stage storage medium 60 has a far smaller capacity than the first-stage storage medium 30. It is thus required for the second-stage storage medium 60 to efficiently store all information of target moving pictures with no excess or deficiency of code amounts. Usually, a moving picture or a TV program lasts for 30 minutes to 2 hours. Therefore, on average, two to six moving pictures (such as, TV programs) are recorded in one second-stage storage medium 60.

The bitstream converter 40 re-encodes (converts) an input bitstream into a different format type of bitstream. The input bitstream is re-encoded after decoded if it is an MPEG-bitstream.

A coding technique (format) for the bitstream converter 40 to the input bitstream after conversion may be the same as or different from that of the encoder 20. Different from the encoder 20 is control of the amount of generated codes. In other words, the encoder 20 controls the amount of generated codes at a given constant target bit rate whereas the bitstream converter 40 does it at a target bit rate set per data unit, such as, GOP (Group of Pictures), frame or slice (16 lines).

The first bitstream supplied to the bitstream converter 40 is then re-encoded and converted into a second bitstream having a different format from the first bitstream, and recorded in the second-stage storage medium 60.

An actual code amount has an error for each data unit, such as GOP, against the target code amount. The error is, however, absorbed in control of the succeeding GOP. The total error for the generated code amounts at the end of the moving-picture video signal is thus a fraction of the code amount of one GOP. Therefore, the target code amount can be set at a relatively small amount against the small total error, thus the total code amount becomes within the capacity of the second-stage storage medium 60. Thus, target moving pictures can be recorded in the second-stage storage medium 60 with no excess or deficiency of code amounts.

The second bitstream is then read from the second-stage storage medium 60 and supplied to the decoder 70 via the switch 50. The second bitstream is decoded into moving pictures which are output via the video output terminal 80.

The first bitstream recoded in the first-stage storage medium 30 is also supplied to an information extractor 90.

The information extractor 90 extracts information on coding difficulty (the code amount required for achieving a given picture quality) from the first bitstream per data unit, such as GOP, frame or slice.

In detail, the information extractor 90 extracts the following two types of information from the first bitstream: the amount of generated codes (information on virtual buffer sufficiency); and the quantization level (quantization stepwidth or scale).

The quantization level is obtained due to that fact that the first bitstream has not been coded so that it can be reproduced with a given picture quality, thus the quantization level varies and the code amount of the first bitstream itself cannot be adjusted into a target code amount.

The information extractor 90 then calculates an amount of quasi-generated codes (the amount of codes which is estimated to be required for achieving a given picture quality) for a given period by using an average of the amount of generated codes and the quantization level.

It is known that the amount of quasi-generated codes is given based on the product of a generated code amount times a quantization level or simply directly from this product, when the quantization level is a medium level. A further precise amount of quasi-generated codes is given based on a quantization level adjusted with respect to subjective picture quality. For example, it can be adjusted into the quantization level to the power of 1.2. The quantization level is also adjustable with information on motion vectors or the mode of inter-picture predictive processing.

When either of parameters, information on the amount of generated codes or on quantization level, is a fixed value, the other varying parameter is used as a parameter indicating the coding difficulty.

There are quantization levels in slice and macroblock according to the MPEG-2 or -4 standards. The slice quantization level can be used for simple processing whereas the macroblock quantization level can be used for precise processing, with an adjusted quantization matrix for further precise processing.

The information extractor 90 obtains the amount of quasi-generated codes per data unit, such as GOP, frame or slice, holds it for the entire period of the input moving-picture video signal, and supplies it to a target rate setter 100.

The target rate setter 100 adjusts the amount of quasi-generated codes for moving pictures to be subjected to the second-stage recording, to set target coded amounts (target rates). Target rates for the entire period of the moving pictures to be subjected to the second-stage recording are held in the target rate setter 100 and supplied to the bitstream converter 40.

Moving pictures (second bitstream) to be recorded in the second-stage recording, among the moving pictures (first bitstream) recorded in the first-stage storage medium 30 in the first-stage recording, are set by a record setter 110 based on information supplied via a record-setting input terminal 120.

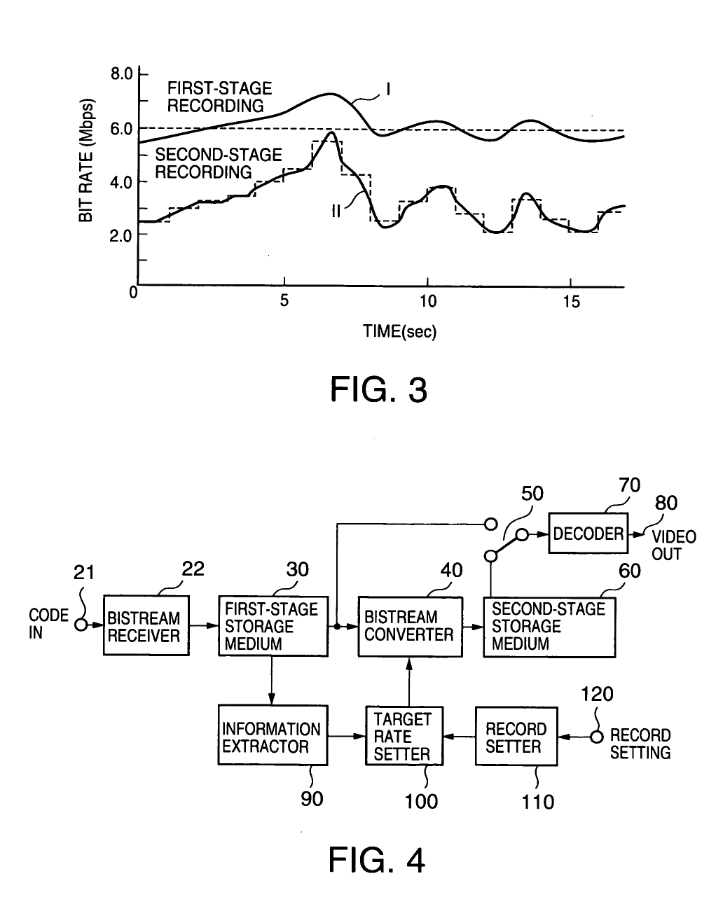

Illustrated in FIG. 3 are target bit rates (depicted by dot lines) and actual bit rates (depicted by solid lines).

An actual rate I for the first bitstream almost follows a given fixed target rate in the first-stage recording whereas another actual rate II for the second bitstream follows a variable target rate in the second-stage recording.

The first bitstream originally having a variable transfer rate is adjusted to have a given target transfer rate (6 Mbps in FIG. 3) in the first-stage recording, thus exhibiting small change in rate but large change in picture quality.

On the contrary, the second bitstream has a drastically low average rate with large change in target rate, thus exhibiting large change in the actual rate II but almost no change (or constant) in picture quality.

Shown in FIG. 4 is a second embodiment of a moving-picture recording system having a moving-picture code amount control apparatus and a moving-picture recording apparatus according to the present invention.

Elements shown in FIG. 4 the same as or analogous to those in FIG. 2 are given the same reference numerals and not explained.

The second embodiment is equipped with a bitstream receiver 22 instead of the encoder 20 shown in FIG. 2 (first embodiment).

A coded signal supplied to the bitstream receiver 22 via a code input terminal 21 is subjected to error correction and demultiplexing, etc., thus converted into a moving-picture bitstream which is recorded in the first-stage storage medium 30.

The input coded signal is carried, for example, by digital broadcasting, at a fixed transfer rate with change in code amount within a given buffer capacity.

The processing after the first-stage recording in the first-stage storage medium 30 is basically the same as that disclosed in the first embodiment. Nevertheless, the amount of quasi-generated codes in the second embodiment mainly depends on the quantization level due to smaller change in code amount compared to the first embodiment.

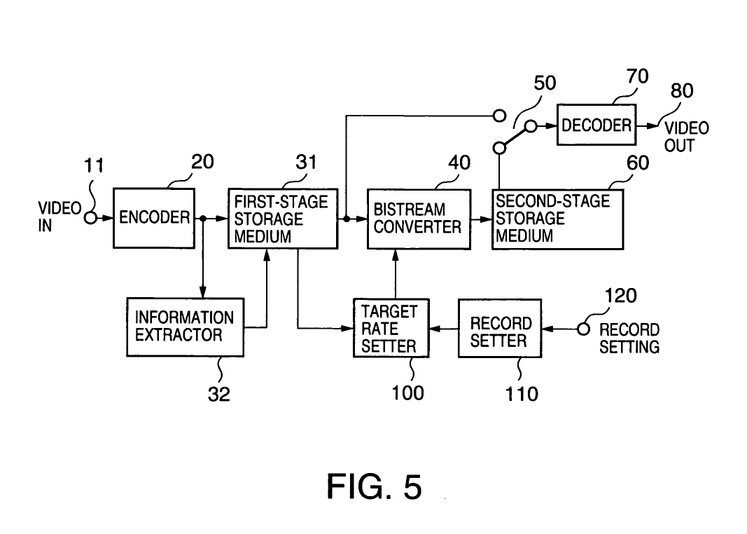

Shown in FIG. 5 is a third embodiment of a moving-picture code amount control and moving-picture recording apparatus according to the present invention.

Elements shown in FIG. 5 the same as or analogous to those in FIG. 2 are given the same reference numerals and not explained.

The third embodiment is equipped with an information extractor 32 and a first-stage storage medium 31 different in operation from the counterparts 90 and 30 shown in FIG. 2 (first embodiment).

In FIG. 5, a first bitstream output from the encoder 20 is supplied to the first-stage storage medium 31 and also the information extractor 32 for extraction of code amount and quantization level.

The information extracted by the information extractor 32 are recorded in the first-stage storage medium 31, in addition to the first bitstream.

The first-stage storage medium 31 obtains information on the amount of quasi-generated codes based on the information on the code amount and quantization level.

The information on the amount of quasi-generated codes is then supplied to the target rate setter 100 from the first-stage storage medium 31 (not from the information extractor 90, as shown in FIG. 2).

The target rate setter 100 sets target rates based on the information on the amount of quasi-generated codes.

The other processing in FIG. 5 is basically the same as that disclosed with respect to FIG. 2, and hence not explained.

The present invention is not limited to those embodiments disclosed above, but also includes computer programs for causing a computer to carry out the processings disclosed with respect to FIGS. 2 to 5.

As disclosed above in detail, according to the present invention, the amount of codes is controlled, which are generated during re-coding in conversion of a first bitstream obtained by efficient coding of a moving-picture video signal to a second bitstream.

Extracted, from the first bitstream, is at least either information on code amount or information on quantization, as a parameter indicating moving-picture coding difficulty. Obtained, from the parameter per given period, is an amount of quasi-generated codes which is estimated to be required for achieving a given picture quality.

The amount of quasi-generated codes is adjusted for each of the given period to obtain a target code amount. The target code amount is assigned to a given portion of the moving-picture video signal so that a total code amount of the given portion of the moving-picture video signal matches a recordable total code amount for a storage medium for storing the given portion of the moving-picture video signal.

The first bitstream is re-coded while code amount control is performed in accordance with the target code amount, thus the first bitstream being converting into the second bitstream to be recorded in the storage medium.

Therefore, the present invention achieves efficient code amount control in accordance with the target code amount given with no tentative coding in converting a first bitstream obtained by efficient coding of a moving-picture video signal to a second bitstream that can be recorded in a storage medium at an appropriate variable rate.

The present invention requires no tentative coding, thus achieving short processing time with no memory for storing uncompressed digital moving-picture video signals.

Moreover, as disclosed above in detail, in recording of moving pictures according to the present invention, a first bitstream obtained by efficient coding of a moving-picture video signal is recorded in a first storage medium, under code amount control for targeting a given fixed transfer bit rate.

Extracted from the first bitstream is at least either information on code amount or information on quantization, as a parameter indicating moving-picture coding difficulty. Obtained from the parameter per given period is an amount of quasi-generated codes which is estimated to be required for achieving a given picture quality.

The amount of quasi-generated codes is adjusted for each of the given period to obtain a target code amount. The target code amount is assigned to a given portion of the moving-picture video signal so that a total code amount of the given portion of the moving-picture video signal matches a recordable total code amount for a second storage medium for storing the given portion of the moving-picture video signal.

The first bitstream is re-coded to convert the first bitstream into a second bitstream having a variable bit rate while performing code amount control in accordance with the target code amount. The second bitstream is recorded in the second storage medium at the variable bit rate.

In this recording, the first bitstream is recorded in the first storage medium at a given fixed transfer bit rate whereas the second bitstream is recorded in the second storage medium at the variable bit rate. Therefore, any portion of the first bitstream recorded in the first storage medium can be recorded in the second storage medium at an appropriate variable bit rate.

Thus, the present invention gives high picture quality to images when reproduced from the second storage medium.

What is claimed is:

1. A method of controlling the amount of codes generated during re-coding in conversion of a first bitstream obtained by efficient coding of a moving-picture video signal to a second bitstream, the method comprising the steps of:
extracting, from the first bitstream, at least either information on code amount or information on quantization, as a parameter indicating moving-picture coding difficulty;
obtaining, from the parameter per given period, an amount of quasi-generated codes which is estimated to be required for achieving a given picture quality;
adjusting the amount of quasi-generated codes for each of the given period to obtain a target code amount;
assigning the target code amount to a given portion of the moving-picture video signal so that a total code amount of the given portion of the moving-picture video signal matches a recordable total code amount for a storage medium for storing the given portion of the moving-picture video signal; and
re-coding the first bitstream while performing code amount control in accordance with the target code amount, thus converting the first bitstream into the second bitstream to be recorded in the storage medium.

2. A moving-picture recording method comprising the steps of:
recording a first bitstream obtained by efficient coding of a moving-picture video signal in a first storage medium, under code amount control for targeting a given fixed transfer bit rate;
extracting, from the first bitstream, at least either information on code amount or information on quantization, as a parameter indicating moving-picture coding difficulty;
obtaining, from the parameter per given period, an amount of quasi-generated codes which is estimated to be required for achieving a given picture quality;
adjusting the amount of quasi-generated codes for each of the given period to obtain a target code amount;
assigning the target code amount to a given portion of the moving-picture video signal so that a total code amount of the given portion of the moving-picture video signal matches a recordable total code amount for a second storage medium for storing the given portion of the moving-picture video signal; and
re-coding the first bitstream to convert the first bitstream into a second bitstream having a variable bit rate while performing code amount control in accordance with the target code amount; and
recording the second bitstream in the second storage medium at the variable bit rate.

3. A moving-picture code amount control apparatus comprising:
an information extractor to extract at least either information on code amount or information on quantization, as a parameter indicating moving-picture coding difficulty, from a first bitstream obtained by efficient coding of a moving-picture video signal, and obtain, from the parameter per given period, an amount of quasi-generated codes which is estimated to be required for achieving a given picture quality;
a target code amount setter to adjust an amount of quasi-generated codes for each of the given period to obtain a target code amount and assign the target code amount to a given portion of the moving-picture video signal so that a total code amount of the given portion of the moving-picture video signal matches a recordable total code amount for a storage medium for storing the given portion of the moving-picture video signal; and
an encoder to re-code the first bitstream while performing code amount control in accordance with the target code amount, thus converting the first bitstream into a second bitstream to be recorded in the storage medium.

4. A moving-picture recording apparatus comprising:
a first recorder to record a first bitstream obtained by efficient coding of a moving-picture video signal in a first storage medium, under code amount control for targeting a given fixed transfer bit rate;
an information extractor to extract, from the first bitstream, at least either information on code amount or information on quantization, as a parameter indicating moving-picture coding difficulty, and obtain, from the parameter per given period-, an amount of quasi-generated codes which is estimated to be required for achieving a given picture quality;
a target code amount setter to adjust an amount of quasi-generated codes for each of the given period to obtain a target code amount and assign the target code amount to a given portion of the moving-picture video signal so that a total code amount of the given portion of the moving-picture video signal matches a recordable total code amount for a second storage medium for storing the given portion of the moving-picture video signal;
a bitstream convertor to re-code the first bitstream while performing code amount control in accordance with the target code amount, thus converting the first bitstream into a second bitstream having a variable transfer bit rate; and
a recorder to recode the second bitstream in the second storage medium at the variable transfer bit rate.
